(19) United States
(12) Patent Application Publication
(10) Pub. No.: US 2026/0298323 A1
(43) Pub. Date: Oct. 1, 2026

(54) LIMITED SLIP DIFFERENTIAL WITH FULL DIFFERENTIAL LOCK DRIVE SUBASSEMBLY

(71) Applicant: TEAM Industries, Inc., Bagley, MN (US)

(72) Inventor: Zoran Vuksa, Grand Forks, ND (US)

(73) Assignee: TEAM Industries, Inc., Bagley, MN (US)

(21) Appl. No.: 19/578,814

(22) Filed: Mar. 25, 2026

Related U.S. Application Data
(60) Provisional application No. 63/778,214, filed on Mar. 26, 2025.

(51) Int. Cl. F16H 48/24; F16H 48/22; F16H 48/34

(52) U.S. Cl. CPC F16H 48/24; F16H 48/22; F16H 48/34; F16H 2048/346

(57) ABSTRACT

A limited slip differential with full differential lock drive subassembly is provided. A carrier of the differential is coupled to a ring gear. A first side gear is received within a ring gear hub. A second side gear is received within the carrier. A plurality of spider gears are configured to convey torque between the first side gear and the second side gear. A first clutch pack is configured to selectively convey friction torque between the ring gear hub and the first side gear. A second clutch pack is configured to selectively convey friction torque between the carrier and the second side gear. An engagement dog is configured to selectively lock rotation of the ring gear to one of the first side gear and the second side gear when the differential is in a lock configuration.

### CROSS-REFERENCE TO RELATED APPLICATIONS

This Application claims priority to U.S. Provisional Application Ser. No. 63/778,214, titled Differential with a Limited Slip Differential with Full Differential Lock Drive Subassembly, filed on Mar. 26, 2025, which is incorporated in its entirety herein by reference.

### BACKGROUND

A differential is a gear train that rotationally connects three shafts to transfer rotational motion. For example, the three shafts may include a drive shaft which is typically coupled to a transmission and pair of wheel drive shafts. A differential may allow an outer wheel shaft drive to rotate faster than the inner drive wheel during a turn. One variation of a differential is a limited slip differential. A limited slip differential limits the “slip” on one wheel with the least traction by shifting a portion of the torque to the other wheel with the most traction. Another variation of a differential is a locking differential. A locking differential is designed to selectively “lock” rotation of two of the shafts of the differential together as if on a common shaft. This causes wheels coupled to the respective shafts to turn in unison regardless of the traction (or the lack thereof) available to either wheel individually. Driving conditions and desired driving characteristics may warrant a desire for use of a limited slip differential or a locking differential.

For the reasons stated above and for other reasons stated below which will become apparent to those skilled in the art upon reading and understanding the present specification, there is a need in the art for differential with both limited slip and locking features.

### SUMMARY

The following summary is made by way of example and not by way of limitation. It is merely provided to aid the reader in understanding some of the aspects of the subject matter described. Embodiments provide a differential with both limited slip and locking features.

In one embodiment, a limited slip differential with full differential lock drive subassembly is provided. The differential including a ring gear including a ring gear hub, a carrier, a first side gear, a second side gear, a plurality of spider gears, a first clutch pack, a second clutch pack, and an engagement dog. The ring gear hub is coupled to the ring gear. The ring gear hub has a ring gear central passage. The ring gear hub includes a plurality of spaced bosses that define a plurality of spaced holding slots. The carrier is coupled to the ring gear. The first side gear is received within the ring gear hub. The first gear includes an extending side gear flange having spaced side gear slots. The second side gear is received within the carrier. The plurality of spider gears are configured to convey torque between the first side gear and the second side gear. The first clutch pack is configured to selectively convey friction torque between the ring gear and the first side gear. The first clutch pack is positioned in the ring gear hub with at least a portion of the first clutch pack positioned radially between the plurality of spaced holding slots and the ring gear central passage. The second clutch pack is configured to selectively convey friction torque between the carrier and the second side gear. The engagement dog is configured to selectively lock a rotation of the first side gear to a rotation of the ring gear hub by selectively engaging at least one side gear slot in the side gear flange of the first gear when the differential is in a lock configuration.

In another embodiment, another limited slip differential with full differential lock drive subassembly is provided. The differential includes a ring gear including a ring gear hub, a carrier, a first side gear, a second side gear, a plurality of spider gears, a first clutch pack, second clutch pack, and an engagement dog. The ring gear hub is coupled to the ring gear. The ring gear hub has a ring gear central passage. The ring gear hub further includes a plurality of spaced bosses extending from an inside end surface of the ring gear hub that define a plurality of spaced holding slots. The carrier is coupled to the ring gear hub. The first side gear is received within the ring gear hub. The first gear includes an extending side gear flange that has spaced side gear slots. The side gear flange is positioned between the plurality of spaced bosses of the ring gear hub and an inside side surface of the ring gear hub. The second side gear is received within the carrier. A plurality of spider gears are configured to convey torque between the first side gear and the second side gear. The first clutch pack is configured to selectively convey friction torque between the ring gear hub and the first side gear, the first clutch pack positioned in the ring gear hub with at least a portion of the first clutch pack positioned radially between the plurality of spaced bosses and the ring gear central passage, wherein the first clutch pack includes a plurality of friction plates and a plurality of reaction plates selectively positioned in relation to each other to achieve a desired friction in the first clutch pack, wherein each reaction plate of the plurality of reaction plates includes an extending plate tab that is positioned between an associated holding slot of the plurality of spaced holding slots of ring gear hub to lock the rotation of the plurality of the reaction plates to the rotation of the ring gear hub. The second clutch pack is configured to selectively convey friction torque between the carrier and the second side gear. The engagement dog is configured to selectively lock rotation of the ring gear hub to the first side gear when a lock configuration is selected. The engagement dog includes a plurality of spaced engaging fingers. Each engaging finger of the plurality of spaced engaging fingers of the engagement dogs passes through an associated ring gear slot of a plurality of ring gear slots in the ring gear hub to be selectively received in an associated gear slot of a plurality of the spaced gear slots in the side gear flange of the first gear to selectively lock rotation of the first gear to the rotation of the ring gear hub.

Still in another embodiment, a vehicle that includes a limited slip differential with full differential lock drive subassembly is provided. The vehicle includes a motor configured to generate motor torque and a gear box to communicate the engine torque to a plurality of wheels. The limited slip differential with the full differential lock drive subassembly includes a ring gear including a ring gear hub, a carrier coupled to the ring gear, a first side gear, a second side gear, a plurality of spider gears, a first clutch pack, a second clutch pack, and an engagement dog. The ring gear hub is coupled to the ring gear. The ring gear hub has a ring gear central passage. The ring gear hub includes a plurality of spaced bosses extending from an inside end surface of the ring gear hub that define a plurality of spaced holding slots. The carrier is coupled to the ring gear. The first side gear is received within the ring gear hub. The first gear includes an axially extending side gear flange having spaced side gear slots. The side gear flange is positioned between the plurality of spaced holding tabs of the ring gear hub and an inside side surface of the ring gear hub. The second side gear is received within the carrier. The plurality of spider gears are configured to convey torque between the first side gear and the second side gear. The first clutch pack is configured to selectively convey friction torque between the ring gear and the first side gear. The first clutch pack is positioned in the ring gear hub with at least a portion of the first clutch pack positioned radially between the plurality of spaced hub holding slots and the ring gear central passage. The second clutch pack is configured to selectively convey friction torque between the carrier and the second side gear. The engagement dog is configured to selectively lock a rotation of the first side gear to a rotation of the ring gear hub by selectively engaging at least one side gear slot in the side gear flange of the first gear when the differential is in a lock configuration.

### BRIEF DESCRIPTION OF THE DRAWINGS

The present invention can be more easily understood and further advantages and uses thereof will be more readily apparent, when considered in view of the detailed description and the following figures in which:

FIG. 1 illustrates a side view of a limited slip differential with full differential lock drive subassembly according to an example aspect of the present invention;

FIG. 2A illustrates a first partial unassembled side view of the differential of FIG. 1 according to an example aspect of the present invention;

FIG. 2B illustrates a second partial unassembled side view of the differential of FIG. 1 according to an example aspect of the present invention;

FIG. 3A illustrates an unassembled side view of the limited slip differential with full differential lock drive subassembly of FIG. 1;

FIG. 3B illustrates another side perspective unassembled cross-sectional view of the limited slip differential with full differential lock drive subassembly of FIG. 3A;

FIG. 3C illustrates still another side perspective unassembled view of the limited slip differential with full differential lock drive subassembly of FIG. 3A;

FIG. 4A illustrates an assembled cross-sectional side view of the limited slip differential with full differential lock drive subassembly of FIG. 3A in an unlocked configuration;

FIG. 4B illustrates a partial cross-sectional side view of the limited slip differential with full differential lock drive subassembly of FIG. 3A in the unlocked configuration;

FIG. 5A illustrates an assembled cross-sectional side view of the limited slip differential with full differential lock drive subassembly of FIG. 3A in a locked configuration;

FIG. 5B illustrates a partial cross-sectional side view of the limited slip differential with full differential lock drive subassembly of FIG. 3A in the locked configuration;

FIG. 6 illustrates a side perspective view of an engagement dog according to an example aspect of the present invention;

FIG. 7 illustrates a side perspective view of a shift control arm according to an example aspect of the present invention;

FIG. 8 illustrates a side perspective view of a friction plate according to an example aspect of the present invention;

FIG. 9 illustrates a side perspective view of a Belleville spring according to an example aspect of the present invention;

FIG. 10 illustrates a side perspective view of a reaction plate according to an example aspect of the present invention;

FIG. 11 illustrates a side perspective view of another reaction plate according to an example aspect of the present invention;

FIG. 12A illustrates a first side perspective view of a ring gear according to an example aspect of the present invention;

FIG. 12B illustrates a second side perspective view of the ring gear of FIG. 12A;

FIG. 13A illustrates a first side perspective view of a first side gear according to an example aspect of the present invention;

FIG. 13B illustrates a second side perspective view of the second side gear of FIG. 13A;

FIG. 14A illustrates a first side perspective view of a carrier according to an example aspect of the present invention;

FIG. 14B illustrates a second side perspective view of the carrier of FIG. 14A;

FIG. 15A illustrates a first side perspective view of another carrier according to an example aspect of the present invention;

FIG. 15B illustrates a second side perspective view of the carrier of FIG. 15A;

FIG. 16 illustrates an end view of a reaction plate and friction plate according to an example aspect of the present invention;

FIG. 17A illustrates an assembled cross-sectional side view of a limited slip differential with full differential lock drive subassembly according to an example aspect of the present invention;

FIG. 17B illustrates an assembled cross-sectional side view of a limited slip differential with full differential lock drive subassembly according to an example aspect of the present invention;

FIG. 17C illustrates an assembled cross-sectional side view of a limited slip differential with full differential lock drive subassembly according to an example aspect of the present invention; and

FIG. 18 illustrates a block diagram of a vehicle that includes a limited slip differential with full differential lock drive subassembly according to an example aspect of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

Language such as “coupled with,” “in communication with,” and “in operational communication with” along with derivations, may be used herein. These terms indicate that two or more elements are interacting with each other. The interaction between the two or more elements may be direct or through intermediate elements. Further the interaction may be physical or non-physical. Physical interaction includes physical connecting of the two or more elements. Non-physical interaction includes, but are not limited to, interactions through signals, such as, but not limited to, power signals, light signals, communication signals, etc.

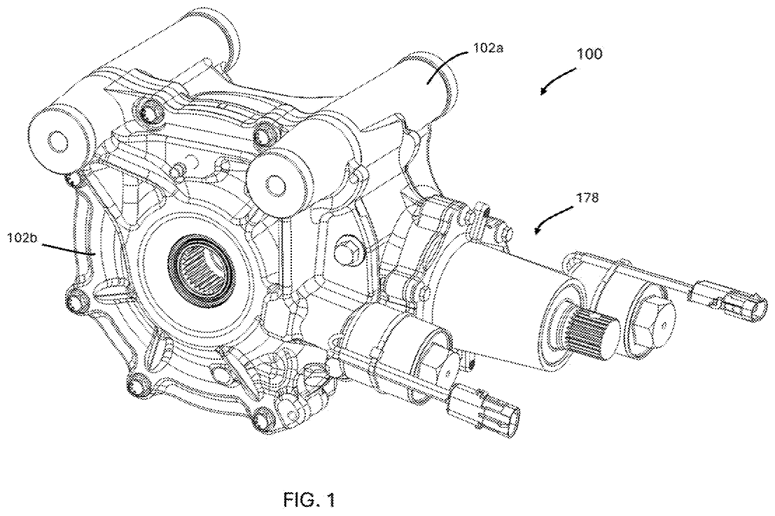

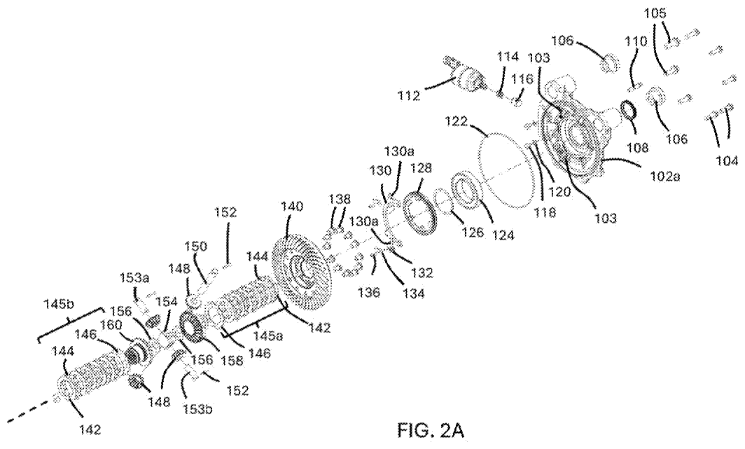

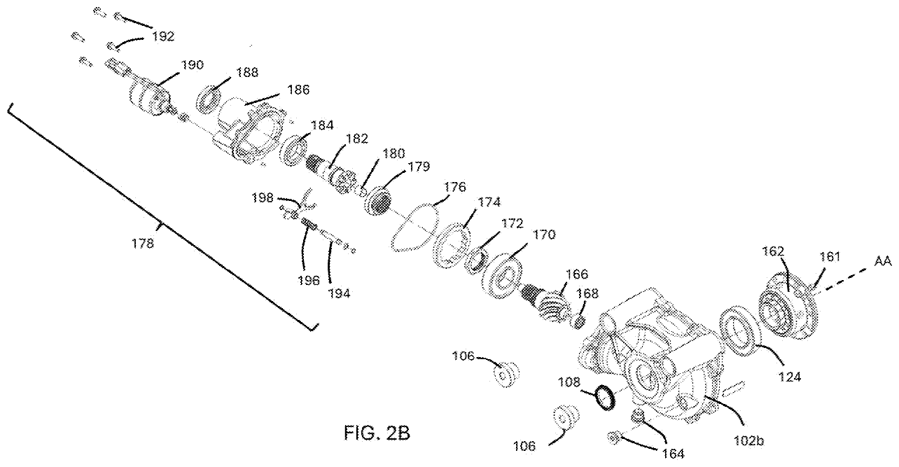

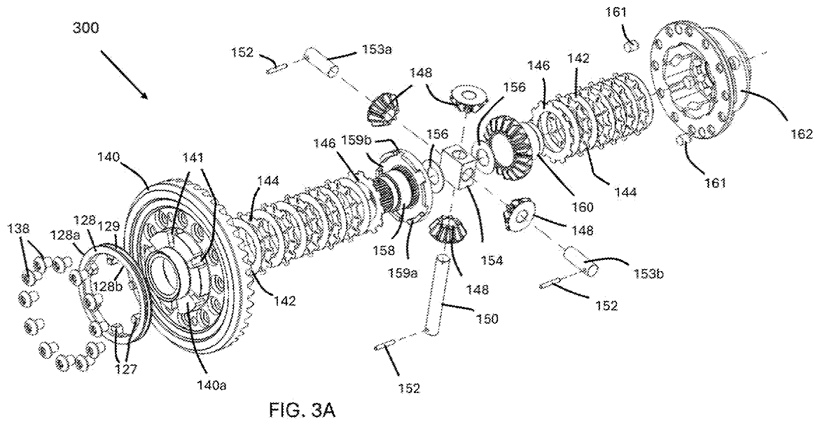

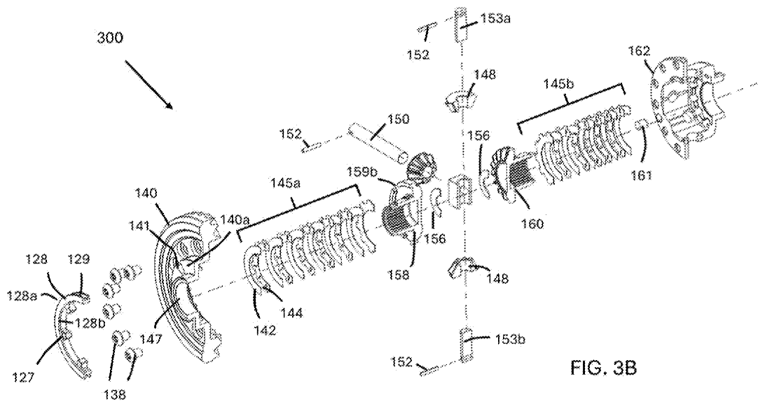

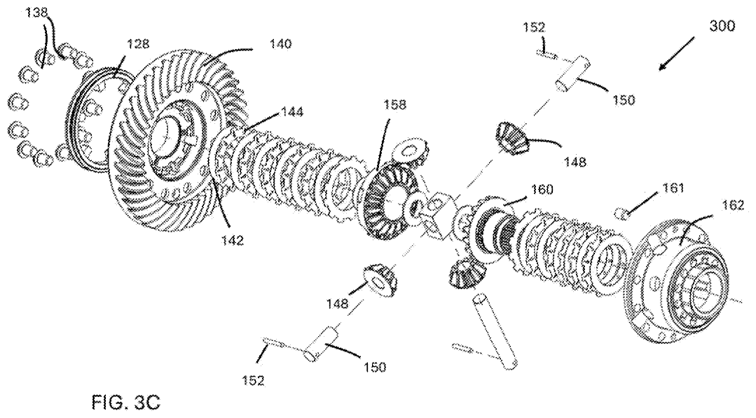

Embodiments of the present invention provide a differential with both limited slip and locking features. FIG. 1 illustrates an assembled side perspective view of a limited slip differential with full differential lock drive subassembly 100. The full differential lock drive subassembly 300 is illustrated in FIG. 3A. The limited slip differential with full differential lock drive subassembly 100 may further include an optional disconnect subassembly 178 of one embodiment. The differential 100 includes a case or housing which, in this example, includes a first case portion 102a and second case portion 102b. An unassembled view of the differential with the limited slip differential with full differential lock drive subassembly 300 and disconnect assembly 178 is illustrated in FIG. 2A and FIG. 2B.

The limited slip differential with full differential lock drive subassembly 100 includes fasteners 104 and fasteners 105 that are configured to couple the first case portion 102a to the second case portion 102b. Spacers 106 are positioned within cylindrical passages in the respective first case portion 102a and the second case portion 102b of the case. An oil seal 108 is positioned in central passages in the first case portion 102a and the second case portion 102b. A tube vent 110 is attached to the first case portion 102a. Also illustrated is a locking solenoid 112, a compression spring 114, a cup 116, shims 120, and thrust buttons 118. An O-ring 122 is positioned between the first case portion 102a and the second case portion 102b. The differential 100 includes ball bearings 124 and shims 126.

An engagement dog 128 (or locking collar), which is part of a differential locking system, is selectively manipulated (moved by) a shift control arm 130. A torsion spring 132, a retention shift fork strap 134 and a fastener 136 are operationally engaged with the shift control arm 130 to bias the engagement dog 128 in a nonlocking configuration. Further illustrated are fasteners 138 used to couple a differential carrier 162 to a ring gear 140. Dowel pins 161 are used to align the carrier 162 and the ring gear 140. The differential 100 includes a plurality of friction plates 142 and a plurality of reaction plates 144 and reaction plates 146. The plurality friction plates 142, the plurality of reaction plates 144 and reaction plates 146 are positioned in relation to each other achieve a desired friction in the first clutch pack 145a to form a selective torque passing first clutch pack 145a. In one example, the friction plates 142 and the reaction plates 144 are alternatively positioned in relation to each other.

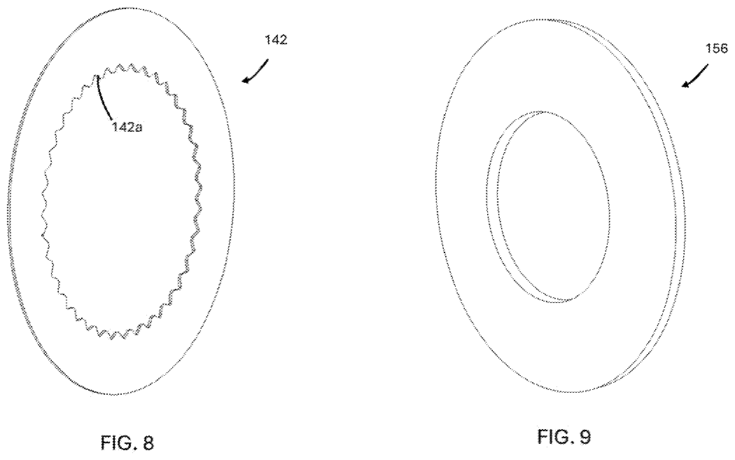

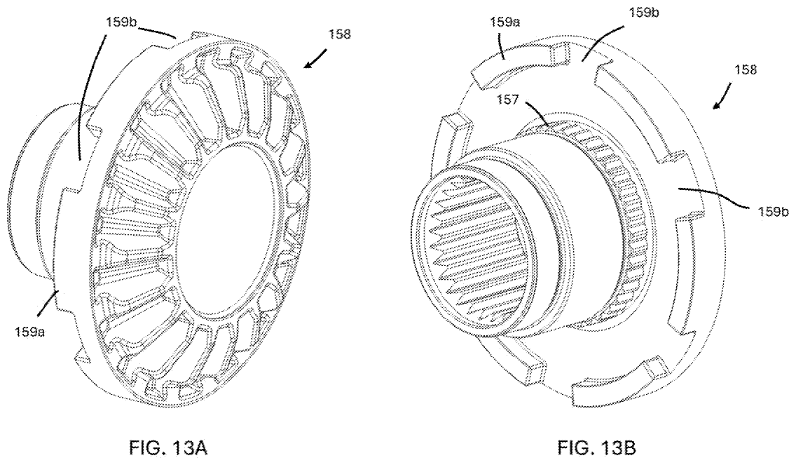

An example of a friction plate 142 is illustrated in FIG. 8. In this example, the friction plate 142 includes internal splines 142a that are configured to engage external splines 157 on the respective first side gear 158 and the second side gear 160 to lock rotation of the friction plates 142 to the first side gear 158 and the second side gear 160 respectfully. An example of the external splines 157 on first side gear 158 in FIG. 13B. Although, a spline to spline connection is illustrated in the figures, any other type of connection that locks rotation of the friction plates and the first side gear 158 and the second side gear 160 may be used. Such types of connections include, but are not limited to, connections that include, slots, grooves, tabs, etc.

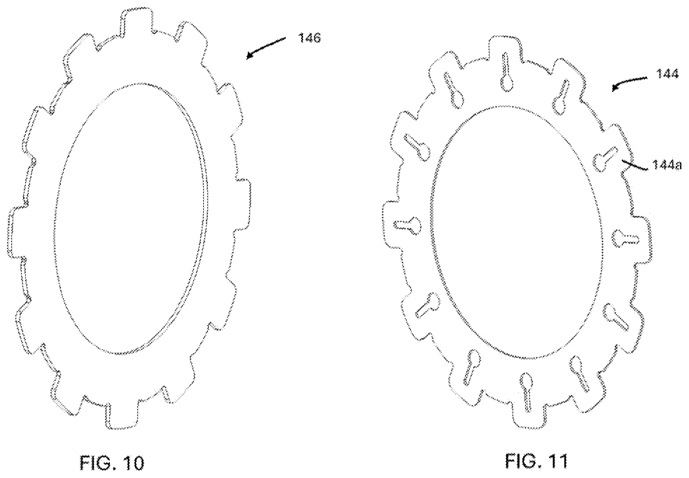

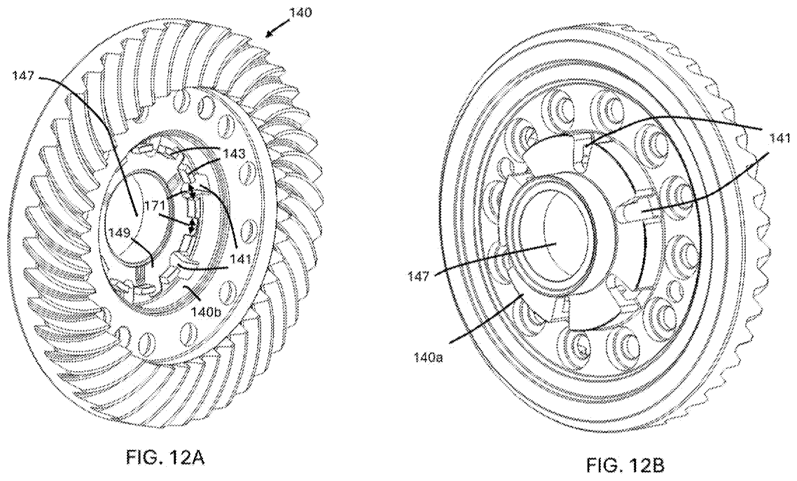

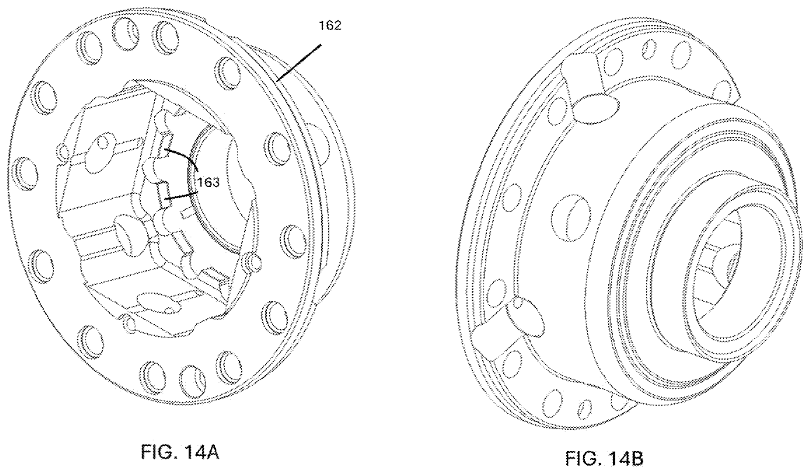

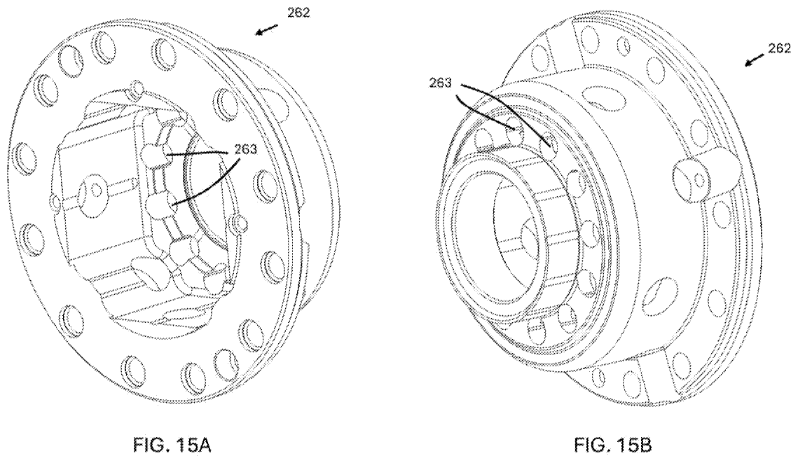

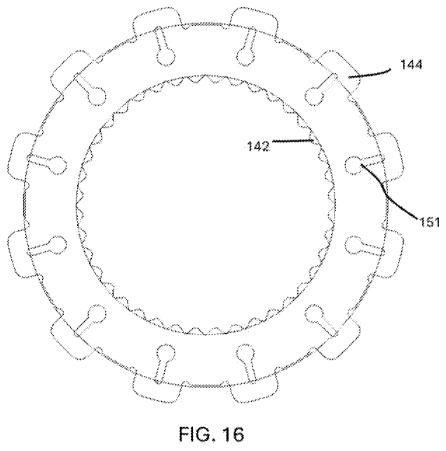

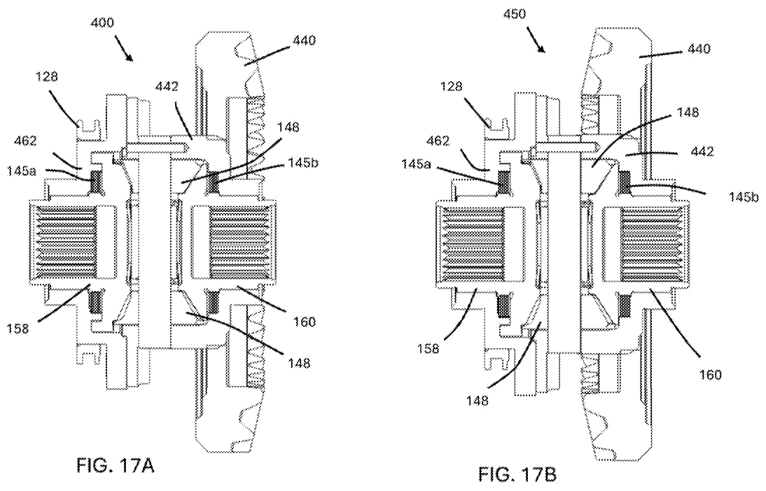

An example of a reaction plate 144 is illustrated in FIG. 11. The reaction plate 144 includes externally extending plate tabs 144a and positioned keyhole shaped passages 151. The plate tabs 144a of the reaction plates 144 associated with the first side gear 158 are positioned between spaced bosses 143 that extend from an inside end surface 149 of the ring gear hub 140a of the ring gear 140 as best illustrated in FIG. 12A. This arrangement locks rotation of these reaction plates 144 (which may be referred to first gear reaction plates) with the ring gear 140. The plate tabs 144a of the reaction plates 144 associated with the second side gear 158 are positioned between carrier holding tabs 163 to lock rotation between the carrier 162 and these reaction plates 144 (second side gear reaction plates). The carrier holding tabs 163 that are formed inside the carrier 162 is best illustrated in FIG. 14A. An example of reaction plate 144 is illustrated in FIG. 10. FIG. 14A and FIG. 14B illustrate a close up view of one example embodiments of a carrier 162. FIG. 15A and FIG. 15B illustrate another example of a carrier 262. In this example, fluid passages 263 provide passages for differential fluid flow (oil) into the gearing and clutch packs. FIG. 16 illustrates an example of a reaction plate 144 placed next to a friction plate 142. A top portion of the keyhole shaped passage 151, in this example, extends beyond an outer diameter of the friction plate 142 to allow for fluid (differential fluid/oil) to be dispersed between adjacent reaction plates 144 and frictions plates 142. In another embodiment, the connections of friction plates and reaction plates in a clutch pack are reversed. For example, in the first clutch pack 145a example, the friction plates 142 may be configured to be coupled to the ring gear hub while the reaction plates 146 may be configured to be coupled to the first gear 158.

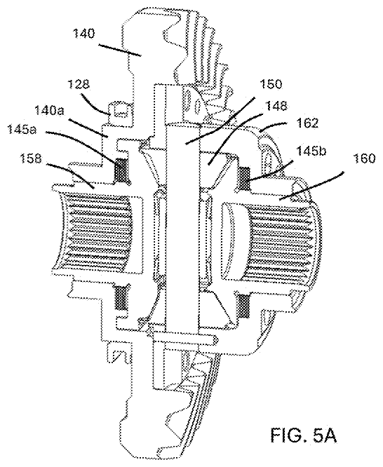

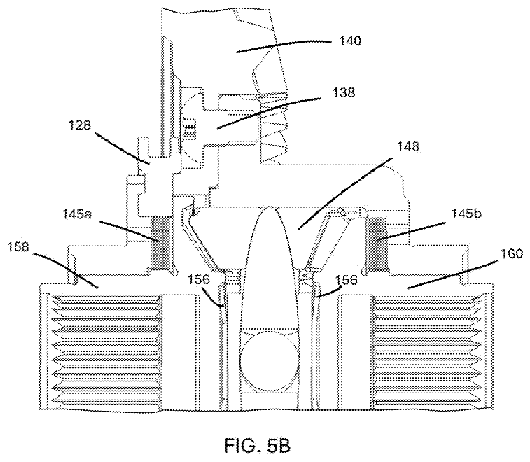

The limited slip differential with full differential lock drive subassembly 100 further includes spider gears 148 that are rotationally mounted on differential pins. The differential pins in this example include a long differential pin 150, a first short differential pin 153a and a second short differential pin 153b are received in a connector 154. A dowel pin 152 retains the spider gears 148 on the respective differential pins 150. Passages in connector 154 hold the differential pins. The Belleville springs 156 provide a biasing force on the respective first side gear 158 and the second side gear 160 to set a spring preload on a respective one of the first clutch pack 145a and a second clutch pack 145b to set the friction between the friction plates and reaction plates in the respective first clutch pack 145a and second clutch pack 145b. An example of a Belleville spring 156 is illustrated in FIG. 9. The positioning of the Belleville springs 156, in an example, is illustrated in FIG. 5B. In another example, the Belleville spring 156, or other type of biasing member that generates a biasing force, is positioned between a respective first side gear 158 and a second side gear 160 and the respective first clutch pack 145a and a second clutch pack 145b. In further another example, a first biasing member is positioned between a surface of the ring gear 140 and the first clutch pack 145a and a second biasing member is positioned between a surface of the carrier 162 and the second clutch pack 145b. Hence, the positioning of the Belleville springs (or other types of biasing members) may be located in different locations to assert a select biasing force on the clutch packs 145a and 145b.

The spider gears 148 engage a first side gear 158 and a second side gear 160. In the example of FIG. 3A, four spider gears 148 are used to convey torque between the first side gear 158 and the second side gear 160. In another example, only two spider gears are used. Hence, the number of spider gears used may vary. The second side gear 160 and a set of the friction plates 142, reaction plates 144 and reaction plate 146 are received within a carrier 162, which in turn is received within the second case portion 102b. The set of the friction plates 142, reaction plates 144 and reaction plate 146 are alternatively positioned in relation to each other to form the selective torque passing second clutch pack 145b. Although the friction plates 142 and reaction plates 144 are described and shown as being alternatively positioned in relation to each other, in other embodiments, other arrangements are used to achieve a desired friction in the respective first clutch pack 145a and second clutch pack 145b.

Plugs 164 are received in ports in the second case portion 102b. A pinion gear 166 and a needle bearing 168 is received within the second case portion 102b. The pinion gear 166 is engaged with the ring gear 140. The differential 100 further includes ball bearing 170, hex pinion hex nut 172, lock nut 174 and O-ring 176 as illustrated in FIG. 2B.

Differential 100 may include a disconnect subassembly 178. The disconnect subassembly 178 is used to disconnect torque between a transmission and the limited slip differential with full differential lock drive subassembly 100. The disconnect subassembly 178 includes a shift collar 179, a plain bearing 180, disconnect shaft 182, a ball bearing 184, disconnect housing 186, a triple lip seal 188, a second solenoid 190 and fasteners 192 that are configured to couple the disconnect housing 186 to the second case portion 102b. The disconnect subassembly 178 further includes shift shaft rail 194, compression spring 196 and a front disconnect fork 198.

FIG. 3A illustrates a side perspective unassembled view of the limited slip differential with full differential lock drive subassembly 300 of the differential 100. FIG. 3B illustrates a side perspective unassembled cross-sectional view of the limited slip differential with full differential lock drive subassembly 300. Further, FIG. 3C illustrates another side perspective unassembled view of the limited slip differential with full differential lock drive subassembly 300. The ring gear 140 in this example, includes spaced ring gear slots 141 that extend radially inward from an outer surface of a centrally located ring gear hub 140a of the ring gear 140 to a central passage of the ring gear hub 140a. An example of a ring gear 140 and ring gear hub 140a are further illustrated in FIG. 12A and FIG. 12B. As illustrated, the ring gear slots 141 pass all the way through the ring gear hub 140a to the central passage 147. The plurality of spaced bosses 143 that extend from an inside end surface 149 of the ring gear hub 140a define a plurality of spaced holding slots 171

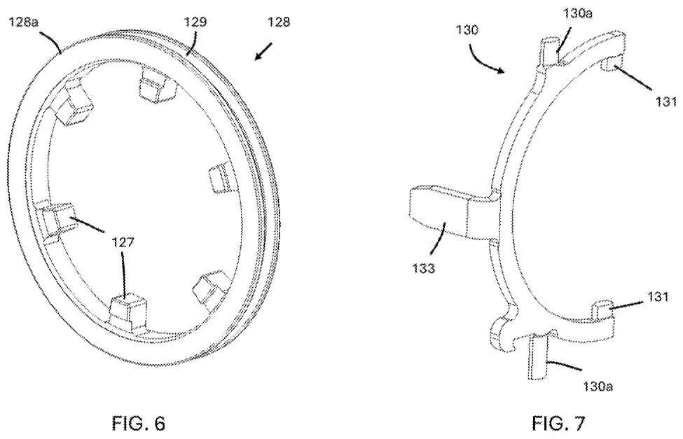

The engagement dog 128, which is best illustrated in FIG. 6, includes an outer surface 128a with a shift control arm groove 129 configured to be engaged by engaging tabs 131 of the shift control arm 130 as illustrated in FIG. 7. The shift control arm 130 further includes a manipulation portion 133 that is operationally engaged with the locking solenoid 112. The engagement dog 128 further includes spaced radially extending inward engaging fingers 127 from an inner surface 128b. Each engaging finger 127 is received in an associated ring gear slot 141 in the ring gear hub 140a of the ring gear 140. In another embodiment, the engaging fingers further extend axially. The shift control arm 130 further includes oppositely radially extending pivot members 130a that are received in pivot nests 103 in the first case portion 102a as best illustrated in FIG. 2A.

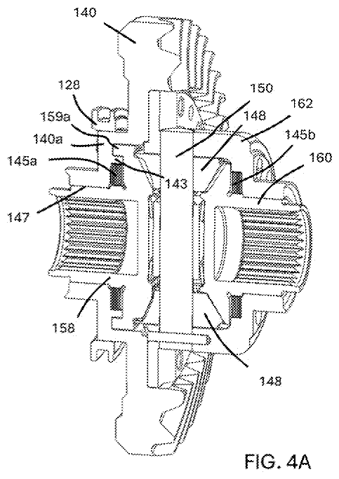

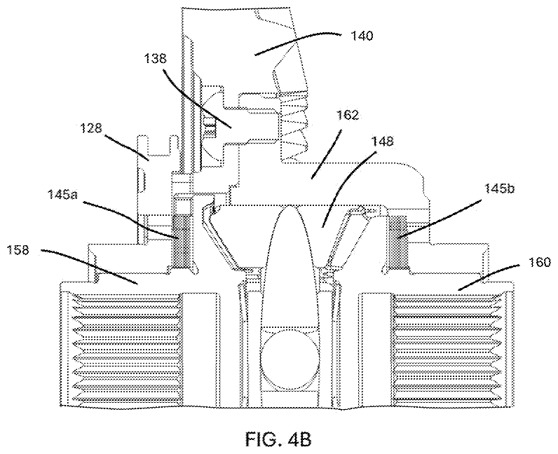

The first side gear 158 includes spaced side gear slots 159b within an axially extending side gear flange 159a as illustrated in the example first side gear 158 of FIG. 13A and FIG. 13B. The axially extending side gear flange 159a extends axially approximate an outer diameter of the first side gear 158. In another example, the gear flange extends radially from an outer diameter of the first ring gear. The first gear 158 is received in part within the central passage 147 in the ring gear hub 140a. The side gear flange 159a is positioned in the holding slots 171 formed by the plurality of spaced bosses 143 and an inside side surface 140b of the ring gear hub 140a at an inside diameter of the ring gear hub 140a in an example. As illustrated in FIG. 4A, the first clutch pack 145a is positioned between the spaced bosses 143 in the ring gear hub 140a and the ring gear central passage 147 in this example. In another example, the plurality of spaced bosses 143 extend to the inside side surface 140b of the of the ring gear hub 140a. In this example, the side gear flange 179a of the first gear abuts the plurality of spaced bosses 143.

In examples, the engagement dog 128 selectively slides on an outer surface of the ring gear hub 140a under control of the shift control arm 130 selectively placing the engaging fingers 127 of the engagement dog 128 (locking collar) through respective ring gear slots 141 into the side gear slots 159b in the side gear flange 159a of the first side gear 158 to lock rotation of the first side gear 158 the rotation of the ring gear 140. Locking rotation of the first side gear 158 to the ring gear 140 also locks rotation of second side gear 160 to rotation of the ring gear 140 via spider gears 148.

FIG. 4A illustrates a cross-sectional side perspective view illustrating the assembled limited slip differential with full differential lock drive subassembly 300 including the ring gear 140 and carrier 162. Further illustrated are the first side gear 158, the second side gear 160, the engagement dog 128, the spider gears 148, first clutch pack 145a, and the second clutch pack 145b. FIG. 4A illustrates the engagement dog 128 engaged on the outside surface of the ring gear hub 140a. The position of the engagement dog 128 on the ring gear hub 140a places the limited slip differential with full differential lock drive subassembly 300 in an unlock configuration. This unlocked configuration is also illustrated in the cross-sectional side view of the limited slip differential with full differential lock drive subassembly 300 of FIG. 4B. In the unlock configuration, normal operations of the limited slip differential with full differential lock drive subassembly 300 are enabled with the first clutch pack 145a conveying torque between the ring gear hub 140a and the first side gear 158 and the second clutch pack 145b conveying torque between the carrier 162 and the second side gear 160. The conveyed torque may be referred to as friction torque since the torque conveyed is provided by the friction generated by the friction plates and reaction plates in the respective first clutch pack 145a and second clutch pack 145b. As illustrated, in the example of FIGS. 4A and 4B, the first clutch pack 145a is positioned in the ring gear hub 140a with at least a portion of the first clutch pack 145a positioned radially between a plurality of spaced hub holding slots 171 (illustrated in FIG. 12A) and a ring gear central passage 147. The hub holding slots 171 are spaces between the bosses 143 that accept tabs 144a of the reaction plates 146 or 144.

FIG. 5A illustrates a cross-sectional side perspective view illustrating the assembled limited slip differential with full differential lock drive subassembly 300 in a locked configuration. The engagement dog 128, engaged on the outside surface of the ring gear hub 140a, is moved so the spaced radially extending inward engaging fingers 127 of the engagement dog 128, which are in the spaced ring gear slots 141 in the ring gear hub 140a of the ring gear 140, move into the spaced side gear slots 159b of the axially extending side gear flange 159a of the first side gear 158. This locks rotation of the ring gear 140 to the first side gear 158. Since the second side gear 160 is locked to the rotation of the first side gear 158 via the spider gears 148, the first side gear 158 and the second side gear 160 move together with rotation of the ring gear 158 in the locked configuration. This locked configuration is also illustrated in the cross-sectional side view of the limited slip differential with full differential lock drive subassembly 300 of FIG. 5B.

In the unlocked configuration, as best illustrated in FIGS. 4A and 4B, the limited slip differential with full differential lock drive subassembly 300 causes the differential 100 to act as a limited slip differential. In the unlocked configuration, the rotation of the first side gear 158 is not locked to the rotation of ring gear hub 140a by the engagement dog 128. As illustrated FIG. 4A, the engagement dog 128 is moved axially on the ring gear hub 140a so the engaging fingers 127 of the engagement dog 128 are not received within the spaced side gear slots 159b of the first side gear 158. Further in the unlocked configuration, torque is transferred between the ring gear 140/carrier 162 to the respective first side gear 158 via first clutch pack 145a and the second side gear 160 via the second clutch pack 145b to provide limited slip differential functions. In one example, the friction of the first clutch pack 145a and the second clutch pack 145b is set by the biasing force provided by the Belleville springs 156 on the respective first side gear 158 and second side gear 160.

In the locked configuration, the first side gear 158 is locked to the rotation of the ring gear/carrier 162 via the engagement dog 128. As discussed above, in the configuration, the rotation of the second side gear 160 is locked with the rotation of the first side gear 158 via the spider gears 148. That is in the locked configuration, the ring gear 140, carrier 162, and the first and second side gears 158 and 160 generally rotate together as one connected unit.

Although, the above description describes the engagement dog 128 as being engaged with the ring gear 140 and the first side gear 158, in other embodiments (not shown), the engagement dog 128 may be engaged with the carrier 162 and the second side gear 160 in a similar fashion to selectively lock rotation of the carrier 162, the second side gear 160, the first side gear 158, and the ring gear 140 together so they all generally rotate together as one connected unit in the locked configuration. Further, embodiments of the differential 100 may be used as front differential or a rear differential in a vehicle.

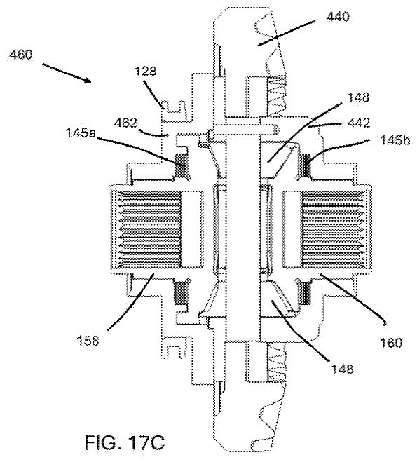

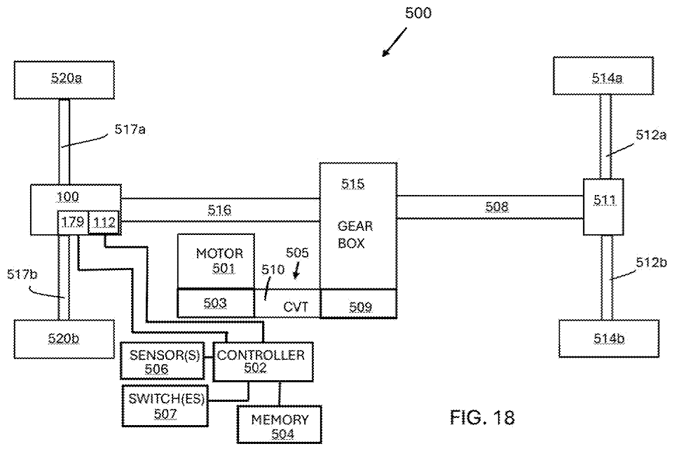

Another example of a limited slip differential with full differential lock drive subassembly 400 is provided in the assembled cross-sectional side view FIG. 17A. In this example, the engagement dog 128 selectively slides on a ring gear hub 462 (carrier cap). The engaging fingers 127 of the engagement dog 128 are received in an associated carrier slots in the ring gear hub 462 (similar to the spaced ring gear slots 141 in the ring gear hub 140a of ring gear 140 described above). The engaging fingers 127 are selectively received in spaced side gear slots of the first side gear 158 to selectively lock rotation of the carrier, first side gear 158, second side gear 160 and ring gear 440 together. The ring gear 440 (in any orientation) in this example is coupled to a carrier 442 (or ring gear hub). In one example, the ring gear 440 may be detached from the carrier 442. This allows the ring gear 440 to be mounted any place and orientation on the carrier 442. For example, the limited slip differential with full differential lock drive subassembly 450 of FIG. 17B illustrates the ring gear 440 being mounted on the carrier 442 in a different orientation than the ring gear 440 illustrated in FIG. 17A. FIG. 17C further illustrates a limited slip differential with full differential lock drive subassembly 460 with the ring gear 440 coupled in a different location on the carrier 442. The ring gear 440 may be coupled to the carrier 442 via fasteners, such as but not limited to, bolts or merged in or welded on to the carrier 442. The examples of FIGS. 17A through 17C illustrate examples where the ring gear 440 is directly coupled to the carrier 442 in different configurations while the carrier 442 is directly coupled to the ring gear hub 462. As discussed above, in regards to the Embodiments of FIG. 1 through 5B, in other examples the ring gear 140 is directly coupled to the ring gear hub 140a. The coupling of the ring gear to one of the ring gear hub or the carrier may be accomplished by one of, but limited to, making the parts out of a single piece of material, with fasteners, such as bolts, rivets, etc., using splines, keys and keyways, press fitting, welding, etc.

Referring to FIG. 18, a vehicle 500 of one example embodiment is illustrated. Vehicle 500 includes a motor 501 to provide engine torque. The motor may be any type of engine that produces engine torque (motor torque) including, but not limited to, internal combustion engines and electrical motors. The motor 501 is part of the drivetrain that provides motor torque, in this example, a continuously variable transmission (CVT 505) is in operational communication with the motor 501. The CVT 505 includes a drive clutch 503 and a driven clutch 509 that are in tortional communication with each other via belt 510 described in this example. A gear box 515 is further in operational communication with the CVT 505. The gear box 515 may include further gearing such as, but not limited to, high, low, reverse, park, etc. A rear prop shaft 508 communicates torque between the gear box 515 and a rear differential 511. Rear wheels 514a and 514b are in operational communication with the rear differential 511 via half shafts 512a and 512b. The vehicle further includes a front differential, such as differential 100 described above. The front differential 100 is in operational communication with the gear box 515 via front prop shaft 516. Front wheels 520a and 520b are in operational communication with the front differential 100 via half shafts 517a and 517b.

The front differential 100 provides the locking feature described above. The vehicle 500. The vehicle 500 further includes a controller 502 and a memory 504. In general, the controller 502 may include any one or more of a processor, microprocessor, a digital signal processor (DSP), an application specific integrated circuit (ASIC), a field program gate array (FPGA), or equivalent discrete or integrated logic circuitry. In some example embodiments, controller 502 may include multiple components, such as any combination of one or more microprocessors, one or more controllers, one or more DSPs, one or more ASICs, one or more FPGAs, as well as other discrete or integrated logic circuitry. The functions attributed to the controller 502 herein may be embodied as software, firmware, hardware or any combination thereof. The controller 502 may be part of a system controller or a component controller such as an engine control unit or transmission control unit. The memory 504 may include computer-readable operating instructions that, when executed by the controller 502 provides locking functions of the differential 100 described above. The computer readable instructions may be encoded within the memory 504. Memory 504 is an appropriate non-transitory storage medium or media including any volatile, nonvolatile, magnetic, optical, or electrical media, such as, but not limited to, a random access memory (RAM), read-only memory (ROM), non-volatile RAM (NVRAM), electrically-erasable programmable ROM (EEPROM), flash memory, or any other storage medium. The controller 502 and memory 504 may be part of an artificial intelligence system, such as a machine learning tool/mechanism implementing that implements a suitable regression model that is capable of learning to optimize vehicle operation, including the operation of differential 100, based on sensed operating characteristics of the vehicle 500 and operator input. The controller 502 in examples is configured to activate the locking solenoid 112 of the full differential lock drive subassembly 300 and the second solenoid 190 of the optional disconnect subassembly 178.

The vehicle 500 further includes one or more sensors 506 that are in communication with the controller 502. The sensors 506 may include, but are not limited to, speed sensors, revolutions per minute (RPM) sensors, acceleration sensors, temperature sensors, vehicle operator input sensors, etc. The controller 502, based at least in part on the operating instructions stored in the memory 504 and sensor information from the sensors 506, in one example, selectively activates the locking features of differential 100. Further, in an example, one or more switches 507 are in communication with controller. In one example, switch 507 provides an on/off switch signal to the controller 502 which controls activation of the locking feature of differential 100 and the operation of the optional disconnect subassembly 178.

The Example of the vehicle 500 of Figure illustrates the differential 100 being used as a front differential. In other examples, the differential 100 is used as a rear differential. Further, in another example, both the front differential and rear differential are differential 100. Moreover, in an example the vehicle may implement a direct drive configuration that implements one or more differential 100.

### EXAMPLE EMBODIMENTS

Example 1 includes a limited slip differential with full differential lock drive subassembly. The differential comprises a ring gear, a ring gear hub, a carrier, a first side gear, a second side gear, a plurality of spider gears, a first clutch pack, a second clutch pack, and engagement dog. The ring gear hub is coupled to the ring gear. The ring gear hub has a ring gear central passage. The ring gear hub includes a plurality of spaced bosses that define a plurality of holding slots. The carrier is coupled to the ring gear. The first side gear is received within the ring gear hub. The first gear includes an extending side gear flange having spaced side gear slots. The second side gear is received within the carrier. The plurality of spider gears are configured to convey torque between the first side gear and the second side gear. The first clutch pack is configured to selectively convey friction torque between the ring gear and the first side gear. The first clutch pack is positioned in the ring gear hub with at least a portion of the first clutch pack positioned radially between the plurality of spaced hub holding slots and the ring gear central passage. The second clutch pack is configured to selectively convey friction torque between the carrier and the second side gear. The engagement dog is configured to selectively lock a rotation of the first side gear to a rotation of the ring gear hub by selectively engaging at least one side gear slot in the gear flange of the first gear when the differential is in a lock configuration.

Example 2 includes the differential of Example 1, wherein the engagement dog has a ring shape with an outer surface and an inner surface. The engagement dog further including the outer surface of the engagement dog having a shift control arm groove, and at least one engaging finger extending from the inner surface of the engagement dog.

Example 3 includes the differential of Example 2, wherein the ring gear hub includes at least one ring gear slot to receive the at least one engaging finger of the engagement dog. Further wherein the at least one engaging finger engages the at least one side gear slot through the at least one ring gear slot to selectively lock the rotation of the first side gear to the rotation of the ring gear hub when the differential is in a lock configuration.

Example 4 includes the differential of any of the Examples 1-3, wherein the ring gear is directly coupled to the ring gear hub.

Example 5 includes the differential of any of the Examples 1-3, wherein the ring gear is directly coupled to the carrier and the carrier is directly coupled to the ring gear hub.

Example 6 includes the differential of any of the Examples 1-5, wherein the first clutch pack includes a plurality of friction plates and a plurality of reaction plates selectively positioned in relation to each other to achieve a desired friction in the first clutch pack.

Example 7 includes the differential of Example 6, further wherein each friction plate of the plurality of friction plates are coupled to the first gear to couple rotation of the plurality of friction plates with the rotation of the first gear and each reaction plates of the plurality of reaction plates are coupled to the ring gear hub to couple rotation of the plurality of reaction plates to the rotation of the ring gear hub.

Example 8 includes the differential of Example 6, further wherein each reaction plate of the plurality of reaction plates includes an extending plate tab positioned in an associated holding slot of the plurality of spaced holding slots of the ring gear hub to lock the rotation of the plurality of the reaction plates to the rotation of the ring gear hub.

Example 9 includes the differential of any of the examples 6-8, wherein each reaction plate has a plurality of spaced passages.

Example 10 includes the differential of Example 9, wherein each spaced passage is keyhole shape that includes a portion that extends beyond an outer diameter of an adjacent friction plate that allows for fluid to be dispersed between the reaction plates and friction plates.

Example 11 includes the differential of Example 10, wherein the at least one spaced passage is aligned with an associated externally extending plate tab of the reaction plate where the portion that extends beyond the outer diameter of the adjacent friction plate that allows for fluid to be dispersed between the reaction plates and the friction plates extends into the associated externally extending plate tab.

Example 12 includes the differential includes any of the Examples 10-11, further including a disconnect subassembly that is configured to selectively disconnect torque between a transmission and the limited slip differential with full differential lock drive subassembly.

Example 13 includes the differential of any of the Examples 1-12, wherein the second clutch pack includes a plurality of friction plates and a plurality of reaction plates that are alternatively positioned, the plurality of friction plates coupled to the second side gear to lock rotation of the friction plates to the second side gear and the plurality of reaction plates coupled to the carrier to lock rotation of the reaction plates to rotation of the carrier.

Example 14 includes the differential of any of the Examples 1-13, wherein the carrier includes a plurality fluid passage to provide fluid communication to the first clutch pack and the second clutch pack.

Example 15 includes a limited slip differential with full differential lock drive subassembly. The differential includes a ring gear including a ring gear hub, a carrier, a first side gear, a second side gear, a plurality of spider gears, a first clutch pack, second clutch pack, and an engagement dog. The ring gear hub is coupled to the ring gear. The ring gear hub has a ring gear central passage. The ring gear hub further includes a plurality of spaced bosses extending from an inside surface of the ring gear that define a plurality of spaced holding slots. The carrier is coupled to the ring gear hub. The first side gear is received within the ring gear hub. The first gear includes an extending side gear flange that has spaced side gear slots. The side gear flange is positioned between the plurality of spaced bosses of the ring gear hub and an inside side surface of the ring gear hub. The second side gear is received within the carrier. A plurality of spider gears are configured to convey torque between the first side gear and the second side gear. The first clutch pack is configured to selectively convey friction torque between the ring gear hub and the first side gear, the first clutch pack positioned in the ring gear hub with at least a portion of the first clutch pack positioned radially between the plurality of spaced bosses and the ring gear central passage, wherein the first clutch pack includes a plurality of friction plates and a plurality of reaction plates selectively positioned in relation to each other to achieve a desired friction in the first clutch pack, wherein each reaction plate of the plurality of reaction plates includes extending plate tabs that is positioned between an associated holding slot of the plurality of the spaced holding slots of the ring gear hub to lock the rotation of the plurality of the reaction plates to the rotation of the ring gear hub. The second clutch pack is configured to selectively convey friction torque between the carrier and the second side gear. The engagement dog is configured to selectively lock rotation of the ring gear hub to the first side gear when a lock configuration is selected. The engagement dog includes a plurality of spaced engaging fingers. Each engaging finger of the plurality of spaced engaging fingers of the engagement dogs passes through an associated ring gear slot of a plurality of ring gear slots in the ring gear hub to be selectively received in an associated gear slot of a plurality of the spaced gear slots in the side gear flange of the first gear to selectively lock rotation of the first gear to the rotation of the ring gear hub.

Example 16 includes the differential of Example 15, further including a shift control arm engaging a shift control arm groove on the outer surface of the engagement dog. The shift control arm includes a manipulation portion that is operationally engaged with a locking solenoid.

Example 17 includes the differential of any of the Examples 15-16, wherein each reaction plate of the first clutch pack has a plurality of keyhole shaped spaced passages, wherein each spaced passage has a portion that extends beyond an outer diameter of an adjacent friction plate that allows for fluid to be dispersed between the reaction plates and friction plates.

Example 18 includes a vehicle that includes a limited slip differential with full differential lock drive subassembly. The vehicle includes a motor configured to generate motor torque and a gear box to communicate the engine torque to a plurality of wheels. The limited slip differential with the full differential lock drive subassembly includes a ring gear, a ring gear hub, a carrier, a first side gear, a second side gear, a plurality of spider gears, a first clutch pack, a second clutch pack, and engagement dog. The ring gear hub is coupled to the ring gear. The ring gear hub has a ring gear central passage. The ring gear hub includes a plurality of spaced bosses extending from an inside end surface of the ring gear hub that define a plurality of spaced holding slots. The carrier is coupled to the ring gear. The first side gear is received within the ring gear hub. The first gear includes an extending side gear flange having spaced side gear slots. The second side gear is received within the carrier. The plurality of spider gears are configured to convey torque between the first side gear and the second side gear. The first clutch pack is configured to selectively convey friction torque between the ring gear and the first side gear. The first clutch pack is positioned in the ring gear hub with at least a portion of the first clutch pack positioned radially between the plurality of spaced hub holding slots and the ring gear central passage. The second clutch pack is configured to selectively convey friction torque between the carrier and the second side gear. The engagement dog is configured to selectively lock a rotation of the first side gear to a rotation of the ring gear hub by selectively engaging at least one side gear slot in the side gear flange of the first gear when the differential is in a lock configuration.

Example 19 includes the vehicle of Example 18, further including the limited slip differential including a locking solenoid configured to engage a manipulation portion of a shift control arm that engages a shift control arm groove on the outer surface of the engagement dog. A controller is configured to activate the locking solenoid based at least in part on one of sensor signals and switch signals and operating instructions.

Example 20 includes the vehicle of any of the Examples 18-19, wherein the first clutch pack includes a plurality of friction plates and a plurality of reaction plates. The reaction plates have a plurality of keyhole shaped spaced passages. Each spaced passage has a portion that extends beyond an outer diameter of an adjacent friction plate that allows for fluid to be dispersed between the reaction plates and friction plates.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A limited slip differential with full differential lock drive subassembly, the differential comprising:
a ring gear;
a ring gear hub coupled to the ring gear, the ring gear hub having a ring gear central passage, the ring gear hub including a plurality of spaced bosses that define a plurality of spaced holding slots;
a carrier coupled to the ring gear hub;
a first side gear received within the ring gear hub, the first gear including an extending side gear flange having spaced side gear slots;
a second side gear received within the carrier;
a plurality of spider gears configured to convey torque between the first side gear and the second side gear;
a first clutch pack configured to selectively convey friction torque between the ring gear and the first side gear, the first clutch pack positioned in the ring gear hub with at least a portion of the first clutch pack positioned radially between the plurality of spaced hub holding slots and the ring gear central passage;
a second clutch pack configured to selectively convey friction torque between the carrier and the second side gear; and
an engagement dog configured to selectively lock a rotation of the first side gear ring gear to a rotation of the ring gear hub by selectively engaging at least one side gear slot in the side gear flange of the first gear when the differential is in a lock configuration.

2. The differential of claim 1, wherein the engagement dog has a ring shape with an outer surface and an inner surface, the engagement dog further comprising:
the outer surface of the engagement dog having a shift control arm groove; and
at least one engaging finger extending from the inner surface of the engagement dog.

3. The differential of claim 2, wherein the ring gear hub includes at least one ring gear slot to receive the at least one engaging finger of the engagement dog, wherein the at least one engaging finger engages the at least one side gear slot through the at least one ring gear slot to selectively lock the rotation of the of the first side gear to the rotation of the ring gear hub when the differential is in the lock configuration.

4. The differential of claim 1, wherein the ring gear is directly coupled to the ring gear hub.

5. The differential of claim 1, wherein the ring gear is directly coupled to the carrier and the carrier is directly coupled to the ring gear hub.

6. The differential of claim 1, wherein the first clutch pack includes a plurality of friction plates and a plurality of reaction plates selectively positioned in relation to each other to achieve a desired friction in the first clutch pack.

7. The differential of claim 6, further wherein each friction plate of the plurality of friction plates are coupled to the first gear to couple rotation of the plurality of friction plates with the rotation of the first gear and each reaction plates of the plurality of reaction plates are coupled to the ring gear hub to couple rotation of the plurality of reaction plates to the rotation of the ring gear hub.

8. The differential of claim 6, further wherein each reaction plate of the plurality of reaction plates includes an extending plate tab positioned in an associated holding slot of the plurality of spaced holding slots of the ring gear hub to lock the rotation of the plurality of the reaction plates to the rotation of the ring gear hub.

9. The differential of claim 6, wherein each reaction plate has a plurality of spaced passages.

10. The differential of claim 9, wherein each spaced passage is keyhole shape that includes a portion that extends beyond an outer diameter of an adjacent friction plate that allows for fluid to be dispersed between the reaction plates and friction plates.

11. The differential of claim 10, wherein at least one spaced passage is aligned with an associated externally extending plate tab of the reaction plate where the portion that extends beyond the outer diameter of the adjacent friction plate that allows for fluid to be dispersed between the reaction plates and the friction plates extends into the associated externally extending plate tab.

12. The differential of claim 10, further comprising:
a disconnect subassembly configured to selectively disconnect torque between a transmission and the limited slip differential with the full differential lock drive subassembly.

13. The differential of claim 1, wherein the second clutch pack includes a plurality of friction plates and a plurality of reaction plates that are alternatively positioned, the plurality of friction plates coupled to the second side gear to lock rotation of the friction plates to the second side gear and the plurality of reaction plates coupled to the carrier to lock rotation of the reaction plates to rotation of the carrier.

14. The differential of claim 13, wherein the carrier includes a plurality fluid passage to provide fluid communication to the first clutch pack and the second clutch pack.

15. A limited slip differential with full differential lock drive subassembly, the differential comprising:
a ring gear;
a ring gear hub coupled to the ring gear, the ring gear hub having a ring gear central passage, the ring gear hub including a plurality of spaced bosses extending from an inside end surface of the ring gear hub that define a plurality of spaced holding slots;
a carrier coupled to the ring gear hub;
a first side gear received within the ring gear hub, the first gear including an extending side gear flange having spaced side gear slots, the side gear flange is positioned between the plurality of spaced bosses of the ring gear hub and an inside side surface of the ring gear hub;
a second side gear received within the carrier;
a plurality of spider gears configured to convey torque between the first side gear and the second side gear;
a first clutch pack configured to selectively convey friction torque between the ring gear and the first side gear, the first clutch pack positioned in the ring gear hub with at least a portion of the first clutch pack positioned radially between the plurality of spaced bosses and the ring gear central passage, wherein the first clutch pack includes a plurality of friction plates and a plurality of reaction plates selectively positioned in relation to each other to achieve a desired friction in the first clutch pack, wherein each reaction plate of the plurality of reaction plates includes an extending plate tab that is positioned between an associated holding slot of the plurality of spaced holding slots of the ring gear hub to lock rotation of the plurality of the reaction plates to rotation of the ring gear hub;
a second clutch pack configured to selectively convey friction torque between the carrier and the second side gear; and
an engagement dog configured to selectively lock rotation of the ring gear hub to the first side gear when a lock configuration is selected, the engagement dog including a plurality of spaced engaging fingers, each engaging finger of the plurality of spaced engaging fingers of the engagement dogs passing through an associated ring gear slot of a plurality of ring gear slots in the ring gear hub to be selectively received in an associated gear slot of a plurality of the spaced gear slots in the gear flange of the first gear to selectively lock rotation of the first gear to rotation of the ring gear hub.

16. The differential of claim 15, further comprising:
a shift control arm engaging a shift control arm groove on an outer surface of the engagement dog, the shift control arm including a manipulation portion that is operationally engaged with a locking solenoid.

17. The differential of claim 15, wherein each reaction plate of the first clutch pack has a plurality of keyhole shaped spaced passages, wherein each spaced passage has a portion that extends beyond an outer diameter of an adjacent friction plate that allows for fluid to be dispersed between the reaction plates and friction plates.

18. A vehicle that includes a limited slip differential with full differential lock drive subassembly, the vehicle comprising:
a motor configured to generate motor torque;
a gear box to communicate the motor torque to a plurality of wheels; and
the limited slip differential with the full differential lock drive subassembly including,
a ring gear;
a ring gear hub coupled to the ring gear, the ring gear hub having a ring gear central passage, the ring gear hub including a plurality of spaced bosses extending from an inside end surface of the ring gear hub that define a plurality of spaced holding slots extending from an inside end surface of the ring gear hub;
a carrier coupled to the ring gear hub;
a first side gear received within the ring gear hub, the first gear including an extending side gear flange having spaced side gear slots;
a second side gear received within the carrier;
a plurality of spider gears configured to convey torque between the first side gear and the second side gear;
a first clutch pack configured to selectively convey friction torque between the ring gear and the first side gear, the first clutch pack positioned in the ring gear hub with at least a portion of the first clutch pack positioned radially between the plurality of spaced holding slots and the ring gear central passage;
a second clutch pack configured to selectively convey friction torque between the carrier and the second side gear; and
an engagement dog configured to selectively lock a rotation of the first side gear ring gear to a rotation of the ring gear hub by selectively engaging at least one side gear slot in the side gear flange of the first gear when the differential is in a lock configuration.

19. The vehicle of claim 18, further comprising:
the limited slip differential including a locking solenoid configured to engage a manipulation portion of a shift control arm that engages a shift control arm groove on an outer surface of the engagement dog; and
a controller configured to activate the locking solenoid based at least in part on one of sensor signals and switch signals and operating instructions.

20. The differential of claim 18, wherein the first clutch pack includes a plurality of friction plates and a plurality of reaction plates, the reaction plates having a plurality of keyhole shaped spaced passages, wherein each spaced passage has a portion that extends beyond an outer diameter of an adjacent friction plate that allows for fluid to be dispersed between the reaction plates and friction plates.
